(19) United States
(12) Patent Application Publication
(10) Pub. No.: US 2012/0136899 A1
(43) Pub. Date: May 31, 2012

(54) ACTIVATION FRAMEWORK FOR TENANT-SPECIFIC FOLLOW-UP

(76) Inventors: Martin Kaiser, Mannheim (DE); Tobias Graf, Eppelheim (DE); Christoph Barbian, Heidelberg (DE)

(21) Appl. No.: 12/955,102

(22) Filed: Nov. 29, 2010

(51) Int. Cl. G06F 17/30

(52) U.S. Cl. 707/783; 707/792; 707/E17.005

(57) ABSTRACT

A system may include one or more tenant-specific databases and a tenant-independent database storing metadata defining data stored in each of the at least one tenant-specific databases. In some aspects, an instruction is received to activate first metadata of a tenant-independent database, at least one adoption task to be performed is determined based on the first metadata, at least one adoption request corresponding to the at least one adoption task is added to a queue, the at least one adoption request is dispatched from the queue to a tenant-specific activator corresponding to a tenant-specific database, and the at least one adoption task corresponding to the at least one adoption request us performed to conform data of the tenant-specific database to the first metadata.

### FIELD

Some embodiments relate to a multi-tenant application platform. More specifically, some embodiments relate to the activation of tenant-independent metadata within a multi-tenant application platform.

### BACKGROUND

An application platform may execute applications (e.g., business processes) to provide business functions to a client. Efficiencies are realized by providing functionality to multiple clients from a single application platform, which may be referred to as a multi-tenant application platform. Due to the sensitivity of business data, it is preferable to isolate the data of each client (i.e., tenant) from the data of each other tenant. More specifically, a tenant of a multi-tenant application platform is unable to access the data of another tenant.

FIG. 1 is a generic block diagram of multi-tenant application platform 100. The elements of tenant A 110 are used to provide business functionality to a first customer, and the elements of tenant B 120 are used to provide business functionality to a second customer. In this regard, tenant A database 114 includes data specific to the first customer, and tenant B database 124 includes data specific to the second customer. Tenant A 110 is isolated from tenant B 120, and tenant-independent database 130 is isolated from both tenant A 110 and tenant B 120. More specifically, tenant A processes 112 are unable to access tenant B database 124, and tenant B processes 122 are unable to access tenant A database 114.

According to some systems, each of tenant-specific databases 114 and 124 include data which is modeled based on metadata stored in tenant-independent database 130. The metadata defines metaobjects and instances thereof (i.e., object models). Types of metaobjects include a Business Object, a Query Definition, a Business Intelligence View, a Floorplan (i.e., a user interface layout), User Interface Text, a Process Component, and a Message Type, among others. A Business Object-type metaobject, for example, is a software model representing real-world items used during the transaction of business. An instance of a Business Object metaobject may comprise a SalesOrder object model or an Organization object model. Instances of these object models, in turn, represent specific data (e.g., SalesOrder SO4711, ACME corporation).

It may be desirable to change the metadata of database 130. The change may provide new functionality, model simplification, or any other desired result. Even though tenant-independent database 130 stores tenant-independent metadata (i.e., the metadata is equally applicable to all tenants), changing the tenant-independent metadata may result in artifacts or content which are tenant-specific. For example, tenant-independent metadata defining a Query Definition may be changed to add fields to the query definition. Accordingly, new data columns should be added to the tenant database tables which store the data of tenant-specific query definitions.

Due to tenant isolation principles, an administrator currently effects the above-described changes by logging on to each tenant and manually coding the changes therein. Systems are therefore desired for facilitating the activation of changed tenant-independent metadata within isolated tenants. Such systems may assist the setup and administration of multi-tenant application platforms.

### BRIEF DESCRIPTION OF THE DRAWINGS

FIG. 1 is a block diagram of a multi-tenant application platform.

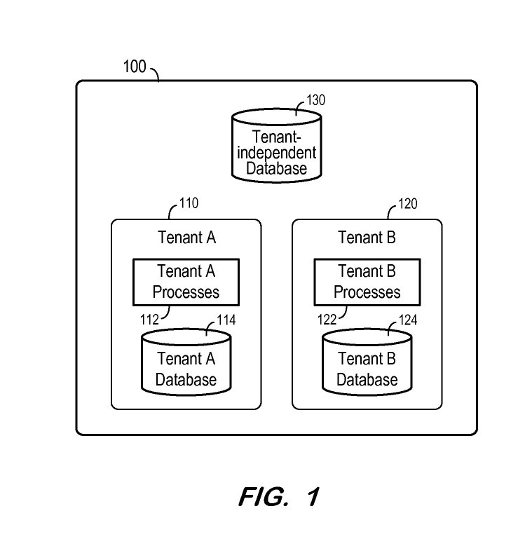

FIG. 2 is a block diagram of a multi-tenant application platform according to some embodiments.

FIG. 3 is a flow diagram of a process according to some embodiments.

FIG. 4 is an outward view of a user interface according to some embodiments.

FIG. 5 is a block diagram illustrating operation of a multi-tenant application platform according to some embodiments.

FIG. 6 is a block diagram illustrating operation of a multi-tenant application platform according to some embodiments.

FIG. 7 is a functional block diagram of an apparatus according to some embodiments.

### DETAILED DESCRIPTION

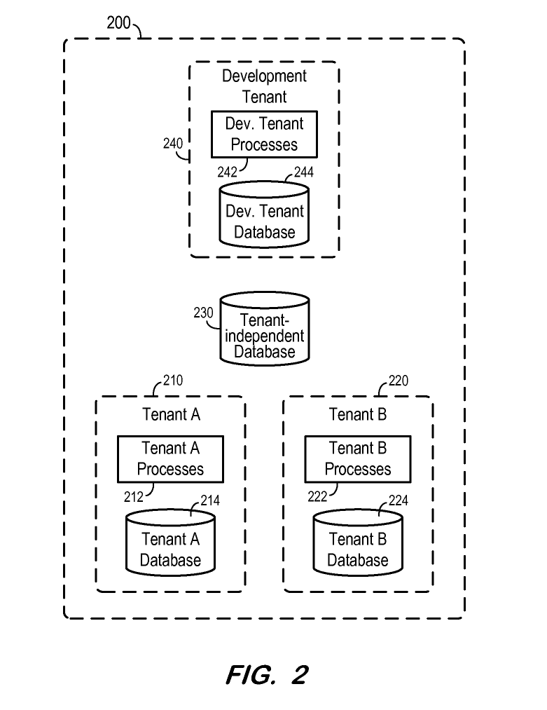

FIG. 2 is a block diagram of system 200 according to some embodiments. FIG. 2 represents a logical architecture for describing some embodiments, and actual implementations may include more or different components arranged in any manner. System 200 may be implemented using any number of computer devices, and one or more processors of system 200 may execute program code to perform processes described herein.

System 200, as well as tenant A 210, tenant B 220, and development tenant 240 are border by dashed lines to illustrate logical, but not necessarily physical, isolation of their respective elements. For example, tenant A processes 212, tenant B processes 222 and development tenant processes 242 may be executed by processor(s) of a single computer server. In some embodiments, however, tenant A database 214 and tenant B database 224 are implemented within physically separate storage devices.

Generally, each system described herein may be implemented by any number of devices in communication via any number of other public and/or private networks. Two or more devices of may be located remote from one another and may communicate with one another via any known manner of network(s) and/or a dedicated connection. Moreover, each device may comprise any number of hardware and/or software elements suitable to provide the functions described herein as well as any other functions. For example, databases 214, 224, 230 and 244 may each be implemented by any number of storage devices that are or become known.

Development tenant 240 may allow a developer to delete, add and/or modify metadata of tenant-independent database 230. As mentioned above, due to tenant isolation, development tenant 240 cannot access data of tenant A database 214 or tenant B database 224. However, by virtue of some of the features described herein, data of tenant A database 214 and tenant B database 224 may be changed to conform to the deleted/added/modified metadata.

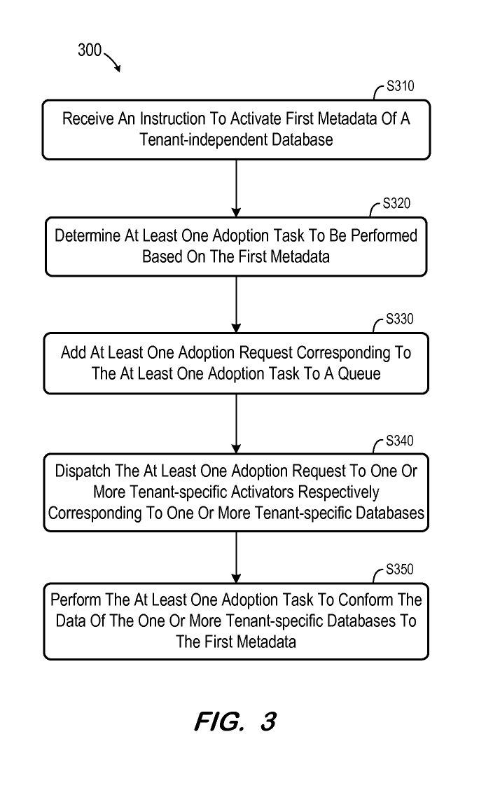

FIG. 3 is a flow diagram of process 300 according to some embodiments. Process 300 may be executed by hardware and/or embodied in processor-executable program code stored on a non-transitory computer-readable medium. Although examples of process 300 will be described with respect to possible logical architectures, embodiments are not limited thereto.

Process 300 may be executed by and/or with respect to a computing system including a tenant-independent database and one or more tenant-specific databases. The tenant-independent database includes metadata defining the data stored in the one or more tenant-specific databases.

Initially, at S310, an instruction to activate first metadata of the tenant-independent database is received. The instruction may be received at S310 by development tenant 240 or by another component of system 200.

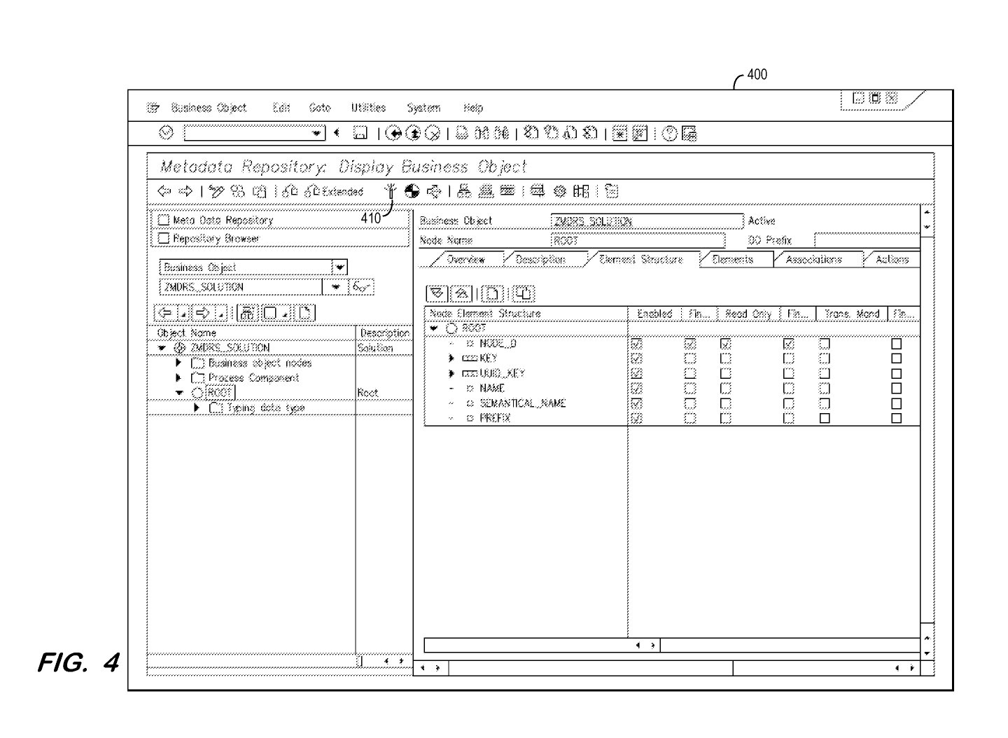

FIG. 4 is a view of user interface 400 for creating/modifying tenant-independent metadata and issuing an instruction to activate such metadata according to some embodiments. Development tenant processes 242 may provide user interface 400 to a client device (not shown) via any suitable mechanism. For example, the client device may present user interface 400 after logging in to a dedicated application (e.g., a user interface portal) provided by development tenant 240. User interface 400 may comprise a Web page provided by a Web server of system 200 and displayed on a Web browser of the client device. In another non-exhaustive example, user interface 400 may be provided by a proprietary application executing on the client device and in communication with development tenant processes 242.

Prior to S310, a developer may manipulate user interface 400 to modify tenant-independent metadata. User interface 400 of FIG. 4 illustrates the modification of metadata defining a Business Object object model. In other examples, the modified metadata may define any of the object models mentioned above, as well as Job Definition, Secondary Index, User Interface Load, and other object models. After creation/modification of the tenant-independent metadata, the developer may select icon 410 to issue an instruction to activate the metadata.

As mentioned above, the instruction may be received by development tenant processes 242 at S310. Next, at least one adoption task to be performed is determined at S320 based on the metadata. The metadata will be referred to as “first” metadata in the foregoing description, although “first” is not intended to denote any temporal or hierarchical property.

The at least one adoption task is intended to conform tenant-specific data of a tenant-specific database (which conforms to a previous version of the metadata of tenant-independent database 230) to the first metadata. For example, if the first metadata adds a field to an object model, an adoption task to add a column to a corresponding database table of the tenant-specific database may be determined at S320. Development tenant 240 may determine the at least one adoption task using any system that is or becomes known.

For example, after import of a transport request, sequencer steps of a transport management system determine follow-up actions such as generating UI loads (in order to speed up UI processing), refreshing TREX indices, etc. Similar logic may be employed at S320 according to some embodiments.

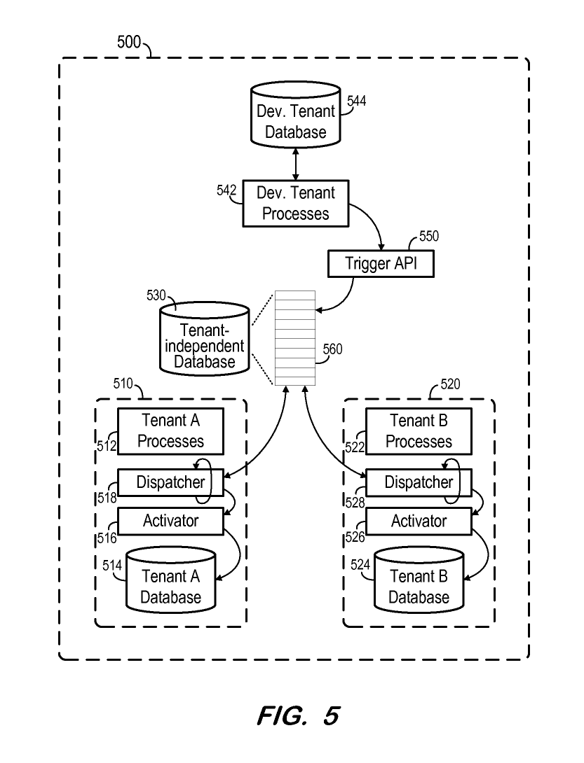

At least one adoption request corresponding to the at least one adoption task is added to a queue at S330. FIG. 5 is a block diagram of system 500 to provide additional details of the operation of some embodiments. The elements of system 500 may be implemented as described above with respect to similarly-named components of system 200.

Trigger API 550 includes one or more methods implemented by program code of system 500. According to the FIG. 5 embodiment, development tenant processes 542 calls a method of trigger API 550 at S330. The at least one adoption task is passed as a parameter of the called method. Next, the method adds at least one adoption request corresponding to the at least one adoption task to queue 560.

Queue 560 may comprise a database table stored in tenant-independent database 530, as shown. By storing queue 560 in database 530, queue 560 may be visible to tenants 510 and 520. The at least one adoption task of queue 560 is then dispatched to the tenants at S340.

In the FIG. 5 embodiment, each of tenants 510 and 520 includes a respective tenant-specific database 514/524, activator 516/526, and dispatcher 518/528. Each of dispatchers 518 and 528 may asynchronously (e.g., every five minutes) determine whether queue 560 includes any adoption requests and, if so, dispatch the adoption requests to its respective tenant-specific activator 516/526 at S340. Next, at S350, each activator 516/526 performs the at least one adoption task determined at S320 to conform the data of its respective tenant-specific database 514/524 to the first metadata.

The adoption tasks may be performed using any suitable system that is or becomes known. In one example, reception of the at least one adoption request implicitly triggers the execution of after-import methods based on the object type of the first metadata. Some systems may employ explicitly-provided execution statements corresponding to the at least one adoption request (e.g., eXecution of PRogram After import (XPRA)). In some embodiments, an activator may call “sequencer steps” at S350, which are traditionally used to cascade follow-up actions/adoptions during import into other systems.

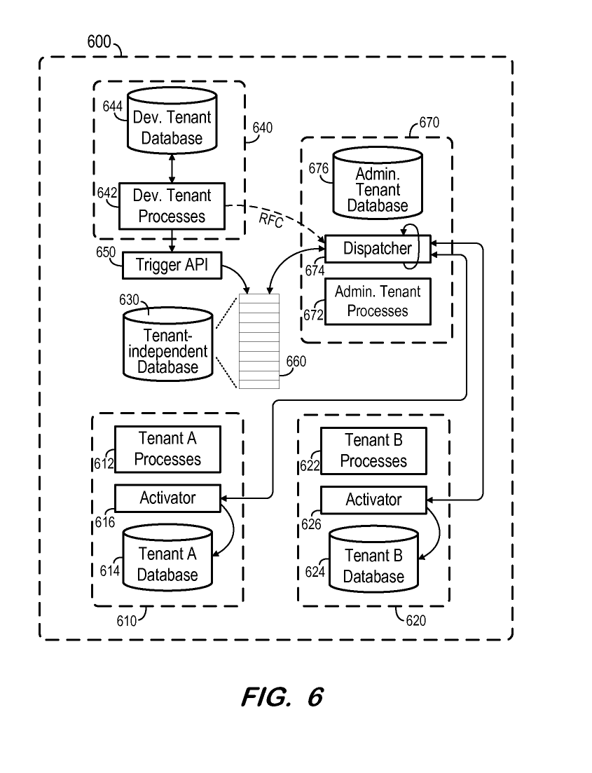

FIG. 6 illustrates an alternative implementation of process 300 according to some embodiments. The elements of system 600 may be implemented as described above with respect to similarly-named components of system 200. Briefly, system 600 includes administrative tenant 670, which is capable of direct communication with tenants 610 and 620. In contrast, and due to tenant isolation, development tenant 640 is unable to communicate directly with tenants 610 and 620.

According to the operation of system 600, steps S310 through S330 of process 300 may proceed as described above with respect to system 500. However, at S340, dispatcher 674 reads queue 660 and calls activators 616 and 626 to dispatch the at least one adoption task of queue 660 to activators 616 and 626. Dispatcher 674 may operate asynchronously as described above (e.g., five minutes after a previous dispatching) or, in some embodiments, S340 may be triggered by a Remote Function Call received from development tenant 640.

At S350, activators 616 and 626 perform the at least one adoption task determined at S320 to conform the data of their respective tenant-specific databases 614/624 to the first metadata. According to some embodiments, activators 616 and 626 transmit a log and/or other results of the adoption tasks to dispatcher 674 after S350. Dispatcher 674 may therefore provide feedback on the execution of the adoption tasks to development tenant 640.

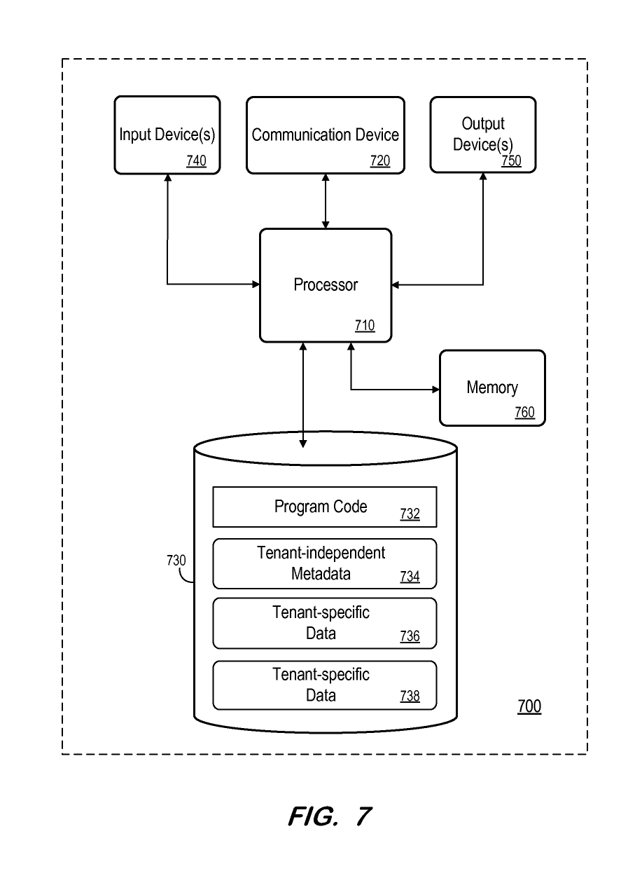

FIG. 7 is a block diagram of apparatus 700 according to some embodiments. Apparatus 700 may comprise a general-purpose computing apparatus and may execute program code to perform any of the functions described herein. Apparatus 700 may comprise an implementation of systems 200, 500 and/or 600. Apparatus 700 may include other unshown elements according to some embodiments.

Apparatus 700 includes processor 710 operatively coupled to communication device 720, data storage device 730, one or more input devices 740, one or more output devices 750 and memory 760. Communication device 720 may facilitate communication with external devices, such as an external design tool. Input device(s) 740 may comprise, for example, a keyboard, a keypad, a mouse or other pointing device, a microphone, knob or a switch, an infra-red (IR) port, a docking station, and/or a touch screen. Input device(s) 740 may be used, for example, to enter information into apparatus 700. Output device(s) 750 may comprise, for example, a display (e.g., a display screen) a speaker, and/or a printer.

Data storage device 730 may comprise any appropriate persistent storage device, including combinations of magnetic storage devices (e.g., magnetic tape, hard disk drives and flash memory), optical storage devices, Read Only Memory (ROM) devices, etc., while memory 760 may comprise Random Access Memory (RAM).

Program code 732 of data storage device 730 may be executable by processor 710 to provide functions described herein, including but not limited to process 300. Embodiments are not limited to execution of these functions by a single apparatus. Tenant-independent metadata 734 may include metadata as described herein, while tenant-specific data 736 and tenant-specific data 738 may comprise data of respective tenants. Accordingly, processor 710 may execute program code 732 to conform tenant-specific data 736 and tenant-specific data 738 to tenant-independent metadata 734 as described herein. As noted, each of tenant-independent metadata 734, tenant-specific data 736 and tenant-specific data 738 may be physically segregated from one another. Data storage device 730 may also store data and other program code for providing additional functionality and/or which are necessary for operation thereof, such as device drivers, operating system files, etc.

The embodiments described herein are solely for the purpose of illustration. Those in the art will recognize other embodiments may be practiced with modifications and alterations limited only by the claims.

What is claimed is:

1. A non-transitory medium having program code stored thereon, the program code executable by a processor to:
receive an instruction to activate first metadata of a tenant-independent database;
determine, based on the first metadata, at least one adoption task to be performed;
add at least one adoption request corresponding to the at least one adoption task to a queue;
dispatch the at least one adoption request from the queue to a tenant-specific activator corresponding to a tenant-specific database; and
perform the at least one adoption task corresponding to the at least one adoption request to conform data of the tenant-specific database to the first metadata.

2. A non-transitory medium according to claim 1, wherein the queue is stored in the tenant-independent database.

3. A non-transitory medium according to claim 1, wherein dispatching of the at least one adoption request comprises dispatching of the at least one adoption request from the queue to a second tenant-specific activator corresponding to a second tenant-specific database, and
wherein performance of the at least one adoption task comprises performance of the at least one adoption task corresponding to the at least one adoption request to conform data of the second tenant-specific database to the first metadata.

4. A non-transitory medium according to claim 1, wherein dispatching of the at least one adoption request comprises receipt of a remote feature call and, in response to the remote feature call, dispatching of the at least one adoption request.

5. A non-transitory medium according to claim 1, wherein dispatching of the at least one adoption request comprises determination that a predefined time period has elapsed since a previous adoption request dispatch, and, in response to the determination, dispatching of the at least one adoption request.

6. A non-transitory medium according to claim 1, the program code further executable by a processor to:
receive a log corresponding to the performance of the at least one adoption task from the tenant-specific activator.

7. A computer-implemented system comprising:
at least one tenant-specific database;
a tenant-independent database storing metadata defining data stored in each of the at least one tenant-specific databases;
at least one storage device storing executable program code; and
a processor to execute the executable program code to provide:
a development tenant to receive an instruction to activate first metadata of the tenant-independent database and to determine, based on the first metadata, at least one adoption task to be performed;
an application programming interface method to receive the at least one adoption task from the development tenant, and to add at least one adoption request corresponding to the at least one adoption task to a queue in response to receiving the at least one adoption task;
a tenant-specific activator corresponding to one of the at least one tenant-specific databases; and
a dispatcher to dispatch the at least one adoption request from the queue to the tenant-specific activator,
wherein the tenant-specific activator performs the at least one adoption task corresponding to the at least one adoption request to conform data of the one of the at least one tenant-specific databases to the first metadata.

8. A computer-implemented system according to claim 7, wherein the queue is stored in the tenant-independent database.

9. A computer-implemented system according to claim 7, the processor to execute the executable program code to provide:
a second tenant-specific activator corresponding to a second one of the at least one tenant-specific databases,
wherein the dispatcher is to dispatch the at least one adoption request from the queue to the second tenant-specific activator, and
wherein the second tenant-specific activator performs the at least one adoption task corresponding to the at least one adoption request to conform data of the second one of the at least one tenant-specific databases to the first metadata.

10. A computer-implemented system according to claim 7, wherein the dispatcher dispatches the at least one adoption request in response to receiving a remote feature call.

11. A computer-implemented system according to claim 7, wherein dispatching the at least one adoption request comprises determining that a predefined time period has elapsed since a previous adoption request dispatch, and, in response to the determination, dispatching the at least one adoption request.

12. A computer-implemented system according to claim 7, wherein the tenant-specific activator transmits a log corresponding to the performance of the at least one adoption task to the dispatcher.

13. A method implemented by a computing system in response to execution of program code by a processor of the computing system, the computing system comprising at least one tenant-specific databases and a tenant-independent database, the tenant-independent database storing metadata defining data stored in each of the at least one tenant-specific databases, the method comprising:
receiving an instruction to activate first metadata of the tenant-independent database;
determining, based on the first metadata, at least one adoption task to be performed;
adding at least one adoption request corresponding to the at least one adoption task to a queue;
dispatching the at least one adoption request from the queue to a tenant-specific activator corresponding to one of the at least one tenant-specific databases; and
performing the at least one adoption task corresponding to the at least one adoption request to conform data of the one of the at least one tenant-specific databases to the first metadata.

14. A method according to claim 13, wherein the queue is stored in the tenant-independent database.

15. A method according to claim 13, wherein dispatching the at least one adoption request comprises dispatching the at least one adoption request from the queue to a second tenant-specific activator corresponding to a second one of the at least one tenant-specific databases, and
wherein performing the at least one adoption task comprises performing the at least one adoption task corresponding to the at least one adoption request to conform data of the second one of the at least one tenant-specific databases to the first metadata.

16. A method according to claim 13, wherein dispatching the at least one adoption request comprises receiving a remote feature call and, in response to the remote feature call, dispatching the at least one adoption request.

17. A method according to claim 13, wherein dispatching the at least one adoption request comprises determining that a predefined time period has elapsed since a previous adoption request dispatch, and, in response to the determination, dispatching the at least one adoption request.

18. A method according to claim 13, further comprising:
receiving a log corresponding to the performance of the adoption tasks from the tenant-specific activator.
